(19) United States
(12) Patent Application Publication
(10) Pub. No.: US 2008/0272574 A1
(43) Pub. Date: Nov. 6, 2008

(54) Hitch ball hole.

(76) Inventor: David Stuart, (US)

Correspondence Address: DAVID STUART, 6 SANDALWOOD COURT, OVIEDO, FL, 32765-7610, US

(21) Appl. No.: 11/420,465

(22) Filed: May 25, 2006

(51) Int. Cl. B60D 1/06

(52) U.S. Cl. 280/511

(57) ABSTRACT

The Hitch Ball Hole is intended to provide added security from theft of existing hitch balls. An appropriate-size hole will be drilled, machined, or bored completely through the threaded portion of the shank to allow a padlock or similar locking mechanism be attached to prevent the nut securing the hitch ball from being unbolted.

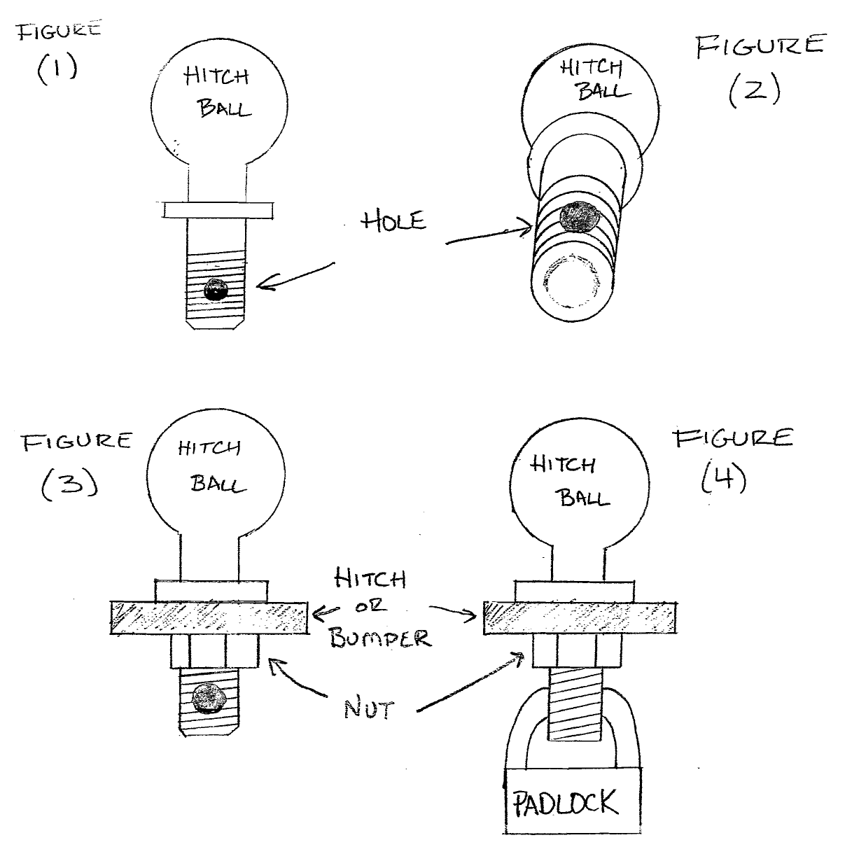

FIG. 1 is a side view of hitch ball with hole drilled or machined into shank.

FIG. 2 is a posterior view of hitch ball from beneath (looking up from below)

FIG. 3 is a side view of the hitch ball installed onto a hitch or bumper with securing nut in place (hole shown empty).

FIG. 4 is a front view of the hitch ball installed onto hitch or bumper with securing nut in place and sample padlock installed.

As seen in FIG. 4, the secured padlock into the invention (hitch-ball-hole) actively secures hitch ball nut from being unbolted, thereby securing hitch ball to hitch or bumper.

1. The invention is any hole drilled completely through the shank of a trailer-hitch-ball to prevent the nut securing the trailer-ball to the hitch from being removed, preventing the trailer-hitch-ball to be removed from the hitch.
